(19) United States
(12) Patent Application Publication
(10) Pub. No.: US 2021/0395432 A1
(43) Pub. Date: Dec. 23, 2021

(54) RIGID POLYISOCYANURATE AND POLYURETHANE FOAMS AND METHODS FOR PREPARING THE SAME

(71) Applicants: Dow Global Technologies LLC, Midland, MI (US); Dow Silicones Corporation, Midland, MI (US)

(72) Inventors: Yanli Feng, Shanghai (CN); Simon Toth, Midland, MI (US); Li Ye, Shanghai (CN); Wei Tang, Shanghai (CN); Nanguo Liu, Midland, MI (US)

(21) Appl. No.: 17/287,633

(22) PCT Filed: Dec. 14, 2018
(86) PCT No.: PCT/CN2018/121007

§ 371 Date: Apr. 22, 2021

(51) Int. Cl. C08G 18/18; C08J 9/12; C08J 9/00; C08J 9/14; C08G 18/22; C08G 18/12; C08G 18/42; C08K 5/5419; C08G 18/61

(52) U.S. Cl. CPC C08G 18/18; C08G 2101/00; C08J 9/0061; C08J 9/146; C08G 18/225; C08G 18/12; C08G 18/42; C08K 5/5419; C08G 18/61; C08J 2205/10; C08J 2203/10; C08J 2203/142; C08J 2375/06; C08G 2110/0025; C08G 2330/00; C08J 9/125

(57) ABSTRACT

A composition for preparing polyisocyanurate and polyurethane foams is provided, comprising A) an isocyanate-reactive component, B) a polyisocyanate component and C) a branched siloxane comprising at least three trimethylsiloxy groups. A method for preparing the polyisocyanurate and polyurethane foams, and foams prepared thereby are also provided.

### FIELD OF THE INVENTION

The present disclosure relates to the field of thermal insulation rigid foams and processes. More particularly, the present disclosure relates to processes and compositions which comprise siloxane to produce rigid polyisocyanurate (PIR) and polyurethane (PUR) foams exhibiting superior thermal insulation and good mechanical properties such as compression strength.

### INTRODUCTION

Rigid polyisocyanurate (PIR) and polyurethane (PUR) foams have outstanding thermal insulation performance and thus can be used in various applications such as building and construction, roofing, tanks, pipes, cold chain and appliances. The reason for these unique characteristics is their cellular structure. With the market demand for better thermal insulation products as well as government regulations on ever higher energy efficiency, there is a critical need to further improve thermal insulation performance of PIR/PUR rigid foam systems. One such solution is to get finer cell sizes to achieve a lower K factor. There remains a need to achieve better thermal insulation and better mechanical properties at the same time.

### SUMMARY OF THE INVENTION

A purpose of the present disclosure is to provide a composition for producing rigid polyisocyanurate (PIR) and polyurethane (PUR) foams. The present disclosure is based on a surprising finding that liquid siloxane with branched structure can effectively decrease the K factor of the resultant rigid PIR/PUR foams while retaining good mechanical strength.

In a first aspect of the present disclosure, the present disclosure provides a composition for preparing rigid polyisocyanurate (PIR) and/or polyurethane (PUR) foams, comprising:

A) an isocyanate-reactive component comprising one or more polyols;

B) a polyisocyanate component selected from a group consisting of an aliphatic polyisocyanate comprising at least two isocyanate groups, an aromatic polyisocyanate comprising at least two isocyanate groups, a cycloaliphatic polyisocyanate comprising at least two isocyanate groups, an araliphatic polyisocyanate comprising at least two isocyanate groups, and prepolymers or combinations thereof;

C) a liquid branched siloxane represented by Formula 1,

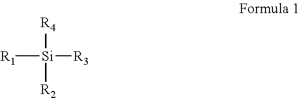

wherein each of R₁, R₂, R₃ and R₄ is independently selected from the group consisting of C₁-C₄ alkyl, e.g. methyl, ethyl, n-propyl, i-propyl, n-butyl, i-butyl, sec-butyl or t-butyl, trimethylsiloxy, tri(trimethylsiloxy)siloxy, di(trimethylsiloxy)methylsiloxy, (trimethylsiloxy)di(methyl)siloxy, a substituting group represented by Formula 2

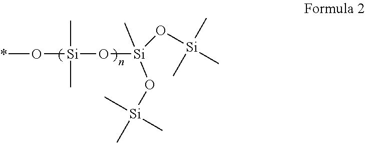

wherein n is an integer of 1, 2, 3, 4, 5, 6, 7, 8, 9 or 10, and * represents the point where the group of Formula 2 is attached to the center silicon atom shown in Formula 1, and

a substituting group represented by Formula 3

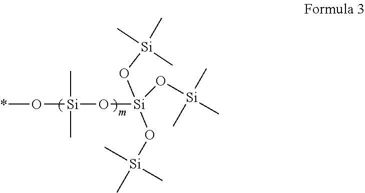

wherein m is an integer of 1, 2, 3, 4, 5, 6, 7, 8, 9 or 10, and * represents the point where the group of Formula 3 is attached to the silicon atom shown in Formula 1,

wherein one or more hydrogen atoms in the methyl group of the above stated substituting groups are optionally substituted with methyl or trimethylsiloxy,

with the proviso that at most three of R₁, R₂, R₃ and R₄ are C₁-C₄ alkyl, preferably at most two of R₁, R₂, R₃ and R₄ are C₁-C₄ alkyl, more preferably at most one of R₁, R₂, R₃ and R₄ is C₁-C₄ alkyl, and more preferably none of R₁, R₂, R₃ and R₄ is C₁-C₄ alkyl; and the siloxane comprises at least three trimethylsiloxy groups.

Preferably, the polyol is selected from a group consisting of aliphatic polyhydric alcohols comprising at least two hydroxy groups, cycloaliphatic or aromatic polyhydric alcohols comprising at least two hydroxy groups, araliphatic polyhydric alcohols comprising at least two hydroxy groups, polyether polyols, polyester polyols, and a combination thereof.

In a second aspect of the present disclosure, the present disclosure provides a polyisocyanurate and polyurethane foam prepared with the composition of the present disclosure, wherein the polyisocyanurate and polyurethane foam is formed by reacting the isocyanate-reactive component with the polyisocyanate component in the presence of the siloxane.

In a third aspect of the present disclosure, the present disclosure provides a method for preparing a polyisocyanurate and polyurethane foam with the composition of the present disclosure, comprising the step of reacting the isocyanate-reactive component with the polyisocyanate component in the presence of the siloxane.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, the term “composition”, “formulation” or “mixture” refers to a physical blend of different components, which is obtained by mixing simply different components by a physical means.

As disclosed herein, “and/or” means “and, or as an alternative”. All ranges include endpoints unless otherwise indicated.

In various embodiments, a composition for producing rigid polyisocyanurate (PIR) and polyurethane (PUR) foams is provided, comprising a polyisocyanate component having two or more isocyanate groups in each molecule, an isocyanate-reactive component including polyols that can react with the isocyanate groups, and a highly branched liquid siloxane.

Without being bound by theory, the polyisocyanate component and the isocyanate-reactive component are generally stored in separate containers until the moment when they are blended together and subjected to the polymerization reaction between the isocyanate groups and hydroxyl groups to form polyisocyanurate and polyurethane. Polyurethane refers to a polymer comprising a main chain formed by the repeating unit (—NH—C(O)—O—) derived from the reaction between isocyanate group and hydroxyl group, while polyisocyanurate comprises an polyisocyanurate ring structure formed by trimerization of isocyanate groups.

As used herein, the terms of “polyisocyanurate and polyurethane”, “polyisocyanurate or polyurethane”, “PIR and PUR”, “PIR or PUR” and “PIR/PUR” are used interchangeably and refer to a polymeric system comprising both polyurethane chain and polyisocyanurate groups, with the relative proportions thereof basically depend on the stoichiometric ratio of the polyisocyanate compounds and polyol compounds contained in the raw materials. Besides, the ingredients, such as catalysts and other additives, and processing conditions, such as temperature, reaction duration, etc., may also slightly influence the relative amounts of the PUR and PIR in the final foam product. Therefore, polyisocyanurate and polyurethane foam (PIR/PUR foam) as stated in the context of the present invention refer to foam obtained as a product of the reaction between the above indicated polyisocyanates and compounds having isocyanate-reactive groups, particularly, polyols. Besides, additional functional groups, e.g. allophanates, biurets or ureas may be formed during the reaction. The PIR/PUR foam is preferably a rigid foam.

The composition of the present disclosure may further comprise catalyst, blowing agent, and other additives.

According to an embodiment of the present disclosure, the composition of the present disclosure is generally prepared and stored as two separate “packages”, i.e. an isocyanate package solely comprising the polyisocyanate component and a polyol package comprising any other components. Namely, the isocyanate-reactive component, siloxane, catalyst, blowing agent and other additives may be mixed together to obtain a “polyol package”, which is then blended with the isocyanate package to produce the PUR/PIR foam. According various embodiments of the present disclosure, the amounts, contents or concentration of the isocyanate-reactive component and the polyisocyanate component are calculated based on the total weight of the composition, i.e. combined weight of the “polyol package” and the “isocyanate package”, while the contents of the other components, e.g. the siloxane, catalyst, blowing and other additives, are based on the weight of the “polyol package”, i.e. the combined weight of all the components excluding the polyisocyanate component or the total weight of the composition minus the weight of the polyisocyanate component. In alternative embodiments, the siloxane, catalyst, blowing and other additives are not mixed with the isocyanate-reactive component and are added as independent streams, but the contents thereof are still calculated based on the combined weight of the “polyol package”.

Isocyanate-Reactive Component

In various embodiments of the present disclosure, the isocyanate-reactive component comprises one or more polyols selected from the group consisting of aliphatic polyhydric alcohols comprising at least two hydroxy groups, cycloaliphatic or aromatic polyhydric alcohols comprising at least two hydroxy groups, araliphatic polyhydric alcohols comprising at least two hydroxy groups, polyether polyol, polyester polyol and mixture thereof. Preferably, the polyol is selected from the group consisting of C2-C16 aliphatic polyhydric alcohols comprising at least two hydroxy groups, C6-C15 cycloaliphatic or aromatic polyhydric alcohols comprising at least two hydroxy groups, C7-C15 araliphatic polyhydric alcohols comprising at least two hydroxy groups, polyester polyols having a molecular weight from 300 to 5,000, polyether polyols having a molecular weight from 300 to 5,000, and combinations thereof.

In a preferable embodiment, the isocyanate-reactive component comprises a mixture of two or more different polyols, such as a mixture of two or more polyether polyols, a mixture of two or more polyester polyols, or a mixture of at least one polyether polyols with at least one polyester polyols. The isocyanate-reactive component has a functionality (average number of isocyanate-reactive groups, particularly, hydroxyl group, in a polyol molecule) of at least 2.0 and a OH number of 80 to 2,000 mg KOH/g, preferably from 150 to 1,000 mg KOH/g, and more preferably from 200 to 500 mg KOH/g.

The polyester polyol is typically obtained by condensation of polyfunctional alcohols having from 2 to 12 carbon atoms, preferably from 2 to 6 carbon atoms, with polyfunctional carboxylic acids having from 2 to 12 carbon atoms, preferably 2 to 6 carbon atoms. Typical polyfunctional alcohols for preparing the polyester polyol are preferably diols or triols and include ethylene glycol, propylene glycol, butylene glycol, pentylene glycol or hexylene glycol. Typical polyfunctional carboxylic acids are selected from the group consisting of succinic acid, glutaric acid, adipic acid, suberic acid, azelaic acid, sebacic acid, decanedicarboxylic acid, maleic acid, fumaric acid and preferably phthalic acid, isophthalic acid, terephthalic acid, the isomeric naphthalenedicarboxylic acids, and combinations thereof. The polyester polyol is preferably terminated with at least two hydroxyl groups. In a preferable embodiment, the polyester polyol has a hydroxyl functionality of 2 to 10, preferably from 2 to 6. In another embodiment, the polyester polyol has a OH number of 80 to 2,000 mg KOH/g, preferably from 150 to 1,000 mg KOH/g, and more preferably from 200 to 500 mg KOH/g. Various molecular weights are contemplated for the polyester polyol. For example, the polyester polyol may have a number average molecular weight of from about 100 g/mol to about 4,000 g/mol, preferably from about 150 g/mol to about 3,000 g/mol, preferably from about 200 g/mol to about 2,000 g/mol, preferably from about 250 g/mol to about 1,000 g/mol, preferably from about 280 g/mol to about 500 g/mol, and more preferably from about 300 g/mol to about 350 g/mol.

The polyether polyols usually have a hydroxyl functionality between 2 and 8, in particular from 2 to 6 and is generally prepared by polymerization of one or more alkylene oxides selected from propylene oxide (PO), ethylene oxide (EO), butylene oxide, tetrahydrofuran and mixtures thereof, with proper starter molecules in the presence of catalyst. Typical starter molecules include compounds having at least 2, preferably from 4 to 8 hydroxyl groups or having two or more primary amine groups in the molecule. Suitable starter molecules are for example selected from the group comprising aniline, EDA, TDA, MDA and PMDA, more preferably from the group comprising TDA and PMDA, an most preferably TDA. When TDA is used, all isomers can be used alone or in any desired mixtures. For example, 2,4-TDA, 2,6-TDA, mixtures of 2,4-TDA and 2,6-TDA, 2,3-TDA, 3,4-TDA, mixtures of 3,4-TDA and 2,3-TDA, and also mixtures of all the above isomers can be used. By way of starter molecules having at least 2 and preferably from 2 to 8 hydroxyl groups in the molecule it is preferable to use trimethylolpropane, glycerol, pentaerythritol, castor oil, sugar compounds such as, for example, glucose, sorbitol, mannitol and sucrose, polyhydric phenols, resols, such as oligomeric condensation products of phenol and formaldehyde and Mannich condensates of phenols, formaldehyde and dialkanolamines, and also melamine Catalyst for the preparation of polyether polyols may include alkaline catalysts, such as potassium hydroxide, for anionic polymerization or Lewis acid catalysts, such as boron trifluoride, for cationic polymerization. Suitable polymerization catalysts may include potassium hydroxide, cesium hydroxide, boron trifluoride, or a double cyanide complex (DMC) catalyst such as zinc hexacyanocobaltate or quaternary phosphazenium compound. In an embodiment of the present disclosure, the polyether polyol has a number average molecular weight in the range from 100 to 10,000 g/mol, preferably in the range from 200 to 8,000 g/mol, more preferably in the range from 300 to 6,000 g/mol, more preferably in the range from 400 to 4,000 g/mol and more preferably in the range from 500 to 3,000 g/mol. In one embodiment, the polyether polyol has a OH number of 80 to 2,000 mg KOH/g, preferably from 150 to 1,000 mg KOH/g, and more preferably from 200 to 500 mg KOH/g.

In general, the concentration of the polyol component used herein may range from about 20 wt % to about 70 wt %, preferably from about 30 wt % to about 60 wt %, more from about 35 wt % to about 50 wt %, based on the total weight of all components in the composition for preparing the PUR/PIR foam.

Polyisocyanate Component

In various embodiments, the polyisocyanate component has an average functionality of at least about 2.0, preferably from about 2 to 10, more preferably from about 2 to about 8, and most preferably from about 2 to about 6. In some embodiments, the polyisocyanate component includes a polyisocyanate compound comprising at least two isocyanate groups. Suitable polyisocyanate compounds include aromatic, aliphatic, cycloaliphatic and araliphatic polyisocyanates having two or more isocyanate groups. In a preferable embodiment, the polyisocyanate component comprises polyisocyanate compounds selected from the group consisting of C₄-C₁₂ aliphatic polyisocyanates comprising at least two isocyanate groups, C₆-C₁₅ cycloaliphatic or aromatic polyisocyanates comprising at least two isocyanate groups, C₇-C₁₅ araliphatic polyisocyanates comprising at least two isocyanate groups, and combinations thereof. In another preferable embodiment, suitable polyisocyanate compounds include m-phenylene diisocyanate, 2,4-toluene diisocyanate and/or 2,6-toluene diisocyanate (TDI), the various isomers of diphenylmethanediisocyanate (MDI), carbodiimide modified MDI products, hexamethylene-1,6-diisocyanate, tetramethylene-1,4-diisocyanate, cyclohexane-1,4-diisocyanate, hexahydrotoluene diisocyanate, hydrogenated MDI, naphthylene-1,5-diisocyanate, or mixtures thereof.

Alternatively or additionally, the polyisocyanate component may also comprise a isocyanate prepolymer having an isocyanate functionality in the range of 2 to 10, preferably from 2 to 8, more preferably from 2 to 6. The isocyanate prepolymer can be obtained by reacting the above stated monomeric isocyanate components with one or more isocyanate-reactive compounds selected from the group consisting of ethylene glycol, 1,2-propanediol, 1,3-propanediol, 1,3-butanediol, 1,4-butenediol, 1,4-butynediol, 1,5-pentanediol, neopentylglycol, bis(hydroxy-methyl) cyclohexanes such as 1,4-bis(hydroxymethyl)cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol and polybutylene glycols. Suitable prepolymers for use as the polyisocyanate component are prepolymers having NCO group contents of from 2 to 40 weight percent, more preferably from 4 to 30 weight percent. These prepolymers are preferably prepared by reaction of the di- and/or poly-isocyanates with materials including lower molecular weight diols and triols. Individual examples are aromatic polyisocyanates containing urethane groups, preferably having NCO contents of from 5 to 40 weight percent, more preferably 20 to 35 weight percent, obtained by reaction of diisocyanates and/or polyisocyanates with, for example, lower molecular weight diols, triols, oxyalkylene glycols, dioxyalkylene glycols, or polyoxyalkylene glycols having molecular weights up to about 800. These polyols can be employed individually or in mixtures as di- and/or polyoxyalkylene glycols. For example, diethylene glycols, dipropylene glycols, polyoxyethylene glycols, ethylene glycols, propylene glycols, butylene glycols, polyoxypropylene glycols and polyoxypropylene-polyoxyethylene glycols can be used. Polyester polyols can also be used, as well as alkane diols such as butane diol. Other diols also useful include bishydroxyethyl- or bishydroxypropyl-bisphenol A, cyclohexane dimethanol, and bishydroxyethyl hydroquinone.

Also advantageously used for the polyisocyanate component are the so-called modified multifunctional isocyanates, that is, products which are obtained through chemical reactions of the above isocyanates compounds. Exemplary are polyisocyanates containing esters, ureas, biurets, allophanates and preferably carbodiimides and/or uretoneimines Liquid polyisocyanates containing carbodiimide groups, uretoneimines groups and/or isocyanurate rings, having isocyanate groups (NCO) contents of from 120 to 40 weight percent, more preferably from 20 to 35 weight percent, can also be used. These include, for example, polyisocyanates based on 4,4′- 2,4′- and/or 2,2′-diphenylmethane diisocyanate and the corresponding isomeric mixtures, 2,4- and/or 2,6-toluenediisocyanate and the corresponding isomeric mixtures; mixtures of diphenylmethane diisocyanates and PMDI; and mixtures of toluene diisocyanates and PMDI and/or diphenylmethane diisocyanates.

Generally, the amount of the polyisocyanate component may vary based on the end use of the rigid PIR/PUR foam. For example, as one illustrative embodiment, the concentration of the polyisocyanate component can be from about 30 wt % to about 80 wt %, preferably from about 40 wt % to about 80 wt %; and more preferably from about 50 wt % to about 80 wt %, based on the total weight of all the components in the composition for preparing the rigid PIR/PUR foam.

The stoichiometric ratio of the isocyanate groups in the polyisocyanate component to the hydroxyl groups in the isocyanate-reactive component is between about 1.0 and 6, preferably from 1.1 to 6, and more preferably from 1.2 to 4.

Siloxane

Without being bound by theory, it is believed that the siloxane with branched structure can effectively facilitate the formation of a superior porous structure in the PUR/PIR foam, thus improving the thermal insulation property thereof.

An typical linear and unbranched siloxane can be represented by the following structure A, in which a main chain consisted of the repeating unit of —(Si(CH₃)₂—O)— is terminated with a tri(methyl)siloxy group on each end and p is an integer of e.g. 1 to 100, hence a unbranched siloxane molecule only comprises two tri(methyl)siloxy groups, and the number of tri(methyl)siloxy groups in one siloxane molecule can be used to determine whether the siloxane is branched.

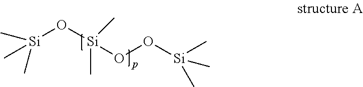

An example of the unbranched siloxane is a commercialized product D10 obtained from DOW and can be represented by the following formula:

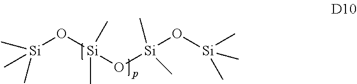

As used herein, the terms of “branched siloxane”, “siloxane with branched structure” and “siloxane with branching functionality” can be used interchangeably and refer to siloxanes comprising at least three tri(methyl)siloxy groups in the molecular structure thereof. It was surprisingly found that one the branched siloxane can achieve desirable effect, while the unbranched siloxane cannot. Particularly, the siloxane that can be used in the present disclosure have a structure represented by Formula 1,

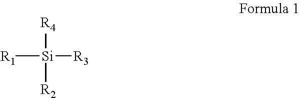

wherein each of R₁, R₂, R₃ and R₄ is independently selected from the group consisting of C₁-C₄ alkyl, trimethylsiloxy, tri(trimethylsiloxy)siloxy, di(trimethylsiloxy)methylsiloxy, (trimethylsiloxy)di(methyl)siloxy, a substituting group represented by Formula 2

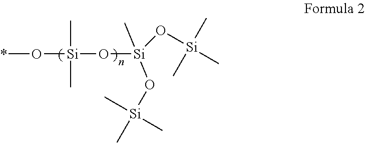

wherein n is an integer of 1, 2, 3, 4, 5, 6, 7, 8, 9 or 10, and * represents the point where the substituting group of Formula 2 is attached to the center silicon atom shown in Formula 1, and

a substituting group represented by Formula 3

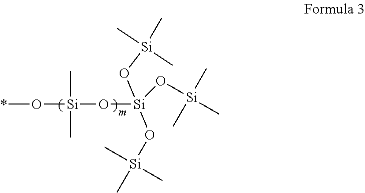

wherein m is an integer of 1, 2, 3, 4, 5, 6, 7, 8, 9 or 10, and * represents the point where the substituting group of Formula 3 is attached to the center silicon atom shown in Formula 1, with the proviso that R₁, R₂, R₃ and R₄ cannot be C₁-C₄ alkyl (preferably, methyl) at the same time, and the siloxane is branched, i.e. it comprises at least three trimethylsiloxy groups. According to a preferable embodiment of the present application, at most three, at most two, or at most one of R₁, R₂, R₃ and R₄ is C₁-C₄ alkyl, while the other substituents directly attached to the center silicon atom of Formula 1 represent the other options as listed above. In an alternative embodiment, none of R₁, R₂, R₃ and R₄ is C₁-C₄ alkyl.

According to an embodiment of the present disclose, the above said substituting groups for R₁, R₂, R₃ and R₄ may be further substituted with e.g. methyl or trimethylsiloxy. For example, assumed that R₁ is a methyl group, then at least one of the hydrogen atoms in the methyl may be replaced with a methyl or a trimethylsiloxy. Besides, it can be seen that methyl is contained as a moiety in all the above said substituting groups other than methyl, and at least one hydrogen atoms of the methyl moiety in any of these substituting groups may be similarly replaced with a methyl or a trimethylsiloxy.

According to one embodiment of the present application, the branched siloxane comprises from 3 to 50 trimethylsiloxy groups, preferably from 4 to 20 trimethylsiloxy groups, more preferably from 4 to 10 trimethylsiloxy groups, more preferably from 4 to 6 trimethylsiloxy groups. According to an alternative embodiment of the present application, the branched siloxane comprises at least 3 silicon atoms, preferably from 3 to 50 silicon atoms, more preferably from 4 to 20 silicon atoms, and the most preferably from 4 to 10 silicon atoms.

According to one embodiment of the present application, the branched siloxane may be represented by any one of the following formulae:

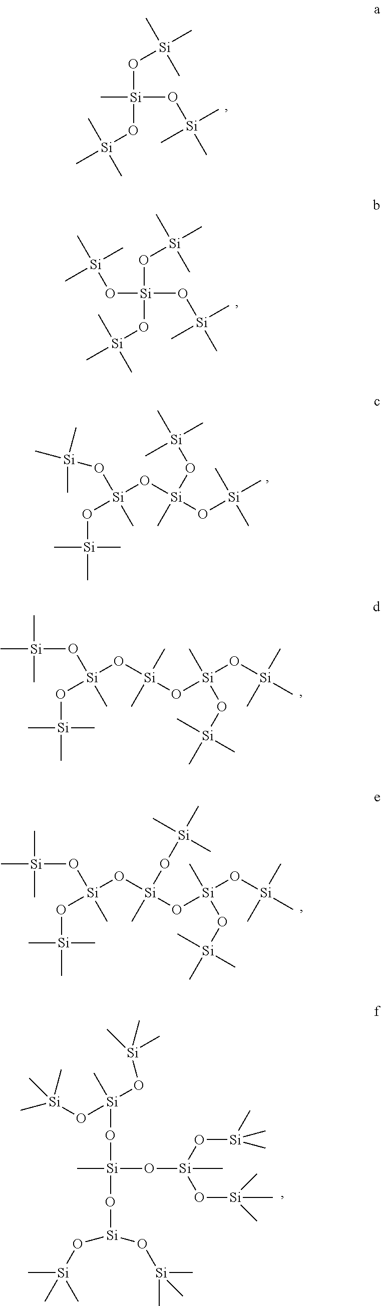

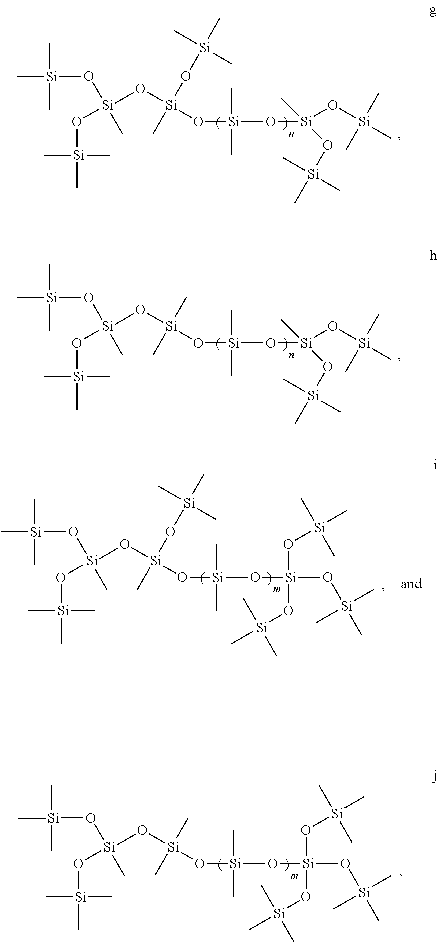

wherein each of n and m independently represents an integer of 1, 2, 3, 4, 5, 6, 7, 8, 9 or 10.

According to one embodiment of the present disclosure, the branched siloxane may be added as a separate stream or in the stream of the isocyanate-reactive component. In one embodiment of the present disclosure, the amount of the branched siloxane is from 0.1 wt % to 5 wt %, preferably from 0.3 wt % to 3 wt %, more preferably from 0.5 wt % to 2 wt %, based on the total weight of all the raw materials other than the isocyanate component.

Blowing Agent

In various embodiments, the blowing agent may be selected based at least in part on the desired density of the final foam. The blowing agent may be added to the polyol package before the polyol package is combined with the polyisocyanate component. Without being bound by theory, the blowing agent may absorb heat from the exothermic reaction of the combination of the isocyanate component with the isocyanate-reactive compounds and vaporize and provide additional gas useful in expanding the polyurethane foam to a lower density. In various embodiments, the blowing agent can be a hydrocarbon. In some embodiments, hydrocarbon or fluorine-containing hydrohalocarbon blowing agents may be employed. The hydrocarbon may be, for example, a hydrofluoroolefin carbon. The blowing agent may comprise, by way of example and not limitation, butane, isobutane, 2,3-dimethylbutane, n- and i-pentane isomers, hexane isomers, heptane isomers, cycloalkanes including cyclopentane (c-pentane), cyclohexane, cycloheptane, and combinations thereof, HFC-245fa (1,1,1,3,3-pentafluoropropane, HFC-365mfc (1,1,1,3,3-penta-flurobutane), HFC-227ea (1,1,1,2,3,3,3-heptafluropropane), HFC-134a (1,1,1,2-tetrafluroethane), combinations thereof, and the like. In one embodiment, the blowing agent is water. In various embodiments, the amount of blowing agent is from about 0.01 wt % to about 40 wt %, more preferably 3 wt % to about 30 wt %, more preferably from 5 wt % to 28 wt %, and the most preferably from 10 wt % to 25 wt %, based on the total weight of the “polyol package”.

Catalyst

Catalyst may include urethane reaction catalyst and isocyanate trimerization reaction catalyst.

Trimerization catalysts may be any trimerization catalyst known in the art that will catalyze the trimerization of an organic isocyanate compound. Trimerization of isocyanates may yield polyisocyanurate compounds inside the polyurethane foam. Without being limited to theory, the polyisocyanurate compounds may make the polyurethane foam more rigid and provide improved reaction to fire. Trimerization catalysts can include, for example, glycine salts, tertiary amine trimerization catalysts, alkali metal carboxylic acid salts, and mixtures thereof. In some embodiments, sodium N-2-hydroxy-5-nonylphenyl-methyl-N-methylglycinate may be employed. When used, the trimerization catalyst may be present in an amount of 0.5-2 wt %, preferably 0.8-1.5 wt % of the “polyol package”.

Tertiary amine catalysts include organic compounds that contain at least one tertiary nitrogen atom and are capable of catalyzing the hydroxyl/isocyanate reaction between the isocyanate component and the isocyanate reacting mixture. Tertiary amine catalysts can include, by way of example and not limitation, triethylenediamine, tetramethylethylenediamine, pentamethyldiethylene triamine, bis(2-dimethylaminoethyl)ether, triethylamine, tripropylamine, tributylamine, triamylamine, pyridine, quinoline, dimethylpiperazine, piperazine, N-ethylmorpholine, 2-methylpropanediamine, methyltriethylenediamine, 2,4,6-tridimethylamino-methyl)phenol, N, N′, N″-tris(dimethyl amino-propyl)sym-hexahydrotriazine, and mixtures thereof. When used, the tertiary amine catalyst may be present in an amount of 0.5-2 wt %, preferably 0.8-1.5 wt % of the “polyol package”.

The composition of the present disclosure may further comprise the following catalysts: tertiary phosphines, such as trialkylphosphines and dialkylbenzylphosphines; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride, stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt.

The total amount of the catalyst component used herein may range generally from about 0.01 wt % to about 10 wt % in polyol package in one embodiment, and from 0.5 wt % to about 5 wt % in polyol package in another embodiment.

Other Additives

Other optional compounds or additives that may be added to composition of the present invention may include, for example, other co-catalysts, surfactants, toughening agents, flow modifiers, adhesion promoters, diluents, stabilizers, plasticizers, catalyst de-activators, dispersing agents, flame retardant and mixtures thereof.

In various embodiments, fire performance may be enhanced by including one or more flame retardants. Flame retardants may be brominated or non-brominated and may include, by way of example and not limitation, tris(1,3-dichloropropyl)phosphate, tris(2-choroethyl)phosphate, tris(2-chloropropyl)phosphate, diammonium phosphate, various halogenated aromatic compounds, antimony oxide, alumina trihydrate, and combinations thereof. When used, the flame retardant may be present in an amount from 0.1 wt % to about 10 wt %, or about 0.5 wt % to about 5 wt % of the polyol package.

Surfactants, especially organic surfactants, may be added to serve as cell stabilizers. Some representative surfactants include organic surfactants containing polyoxy-ethylene-polyoxybutylene block copolymers. It is particularly desirable to employ a minor amount of a surfactant to stabilize the foaming reaction mixture until it cures. Other surfactants that may be useful herein are polyethylene glycol ethers of long-chain alcohols, tertiary amine or alkanolamine salts of long-chain allyl acid sulfate esters, alkylsulfonic esters, alkyl arylsulfonic acids, and combinations thereof. Such surfactants are employed in amounts sufficient to stabilize the foaming reaction against collapse and the formation of large uneven cells. Typically, a surfactant total amount from about 0.2 to about 3 wt %, based on the amount of the polyol package, is sufficient for this purpose.

Other additives such as fillers and pigments may be included in the inventive rigid PIR/PUR foam compositions. Such fillers and pigments may include, in non-limiting embodiments, barium sulfate, calcium carbonate, graphite, carbon black, titanium dioxide, iron oxide, microspheres, alumina trihydrate, wollastonite, glass fibers, polyester fibers, other polymeric fibers, combinations thereof, and the like.

Manufacture Technology

In various embodiments, the PIR/PUR foam is prepared by mixing the reaction components, including the isocyanate reactive component, the siloxane, the catalyst, the blowing agents and any other additives of the “polyol package”, with the isocyanate package at room temperature or at an elevated temperature of 30 to 120° C., preferably from 40 to 90° C., more preferably from 50 to 70° C., for a duration of e.g. 10 seconds to 10 hours, preferably from 2 minutes to 3 hours, more preferable from 10 minutes to 60 minutes. In some embodiments, the isocyanate-reactive compounds, the blowing agent and the siloxane may be mixed prior to or upon addition to the isocyanate component. Other additives, including catalysts, flame retardants, and surfactants, may be added to the polyol package prior to addition of the blowing agent. Mixing may be performed in a spray apparatus, a mix head, or a vessel. Following mixing, the mixture may be sprayed or otherwise deposited onto a substrate or into an open mold. Alternatively, the mixture may be injected inside a cavity, in the shape of a panel or any other proper shapes. This cavity may be optionally kept at atmospheric pressure or partially evacuated to sub-atmospheric pressure.

Upon reacting, the mixture takes the shape of the mold or adheres to the substrate to produce a PIR/PUR foam which is then allowed to cure, either partially or fully. Suitable conditions for promoting the curing of the PIR/PUR polymer include a temperature of from about 20° C. to about 150° C. In some embodiments, the curing is performed at a temperature of from about 35° C. to about 75° C. In other embodiments, the curing is performed at a temperature of from about 45° C. to about 55° C. In various embodiments, the temperature for curing may be selected at least in part based on the time duration required for the PUR/PIR polymer to gel and/or cure at that temperature. Cure time will also depend on other factors, including, for example, the particular components (e.g., catalysts and quantities thereof), and the size and shape of the article being manufactured.

The description hereinabove is intended to be general and is not intended to be inclusive of all possible embodiments of the invention. Similarly, the examples hereinbelow are provided to be illustrative only and are not intended to define or limit the invention in any way. Those skilled in the art will be fully aware that other embodiments, within the scope of the claims, will be apparent from consideration of the specification and/or practice of the invention as disclosed herein. Such other embodiments may include selections of specific components and constituents and proportions thereof; mixing and reaction conditions, vessels, deployment apparatuses, and protocols; performance and selectivity; identification of products and by-products; subsequent processing and use thereof; and the like; and that those skilled in the art will recognize that such may be varied within the scope of the claims appended hereto.

### Examples

Some embodiments of the invention will now be described in the following examples, wherein all parts and percentages are by weight unless otherwise specified.

The information of the raw materials used in the examples is listed in the following Table 1. All the raw materials were directly used as received without further purification and the water is distilled water.

TABLE 1
Raw materials

| Materials | Description | Vendor |
|---|---|---|
| Polyester polyol O | a polyester polyol having a OH number of | Dow Chemicals |
| | around 220, a functionality of 2, and a | |
| | viscosity at 25° C. of 2 Pa · s | |
| Polyester polyol F | a polyester polyol having a OH number of | Dow Chemicals |
| | around 315, a functionality of 2.4, and | |
| | viscosity at 25° C. of 5 Pa · s | |
| Triethyl Phosphate | Flame retardant | Jiangsu Yoke, ICL |
| (TEP) | | |
| VORASURF DC | Surfactant | Dow Chemicals |
| 5374 | | |
| Tegostab B 8421 | Surfactant | Evonik |
| siloxane c | branched siloxane | Dow Chemicals |
| siloxane d | branched siloxane | Dow Chemicals |
| siloxane b | branched siloxane | Sigma-Aldrich |
| D10 | unbranched siloxane | Dow Chemicals |
| Dabco K2097 | Catalyst, a solution of potassium-acetate in | Air Products |
| | diethylene glycol | |
| Polycat 5 (PC-5) | Catalyst, pentamethyldiethylenetriamine | Air Products |
| Water | Blowing agent | / |
| Cyclopentane (CP) | Blowing agent | Beijing Eastern |
| | | Acrylic |
| | | Chemical |
| VORANATE M600 | Polymeric MDI with a NCO% of 30.5, an | Dow Chemicals |
| | average functionality of 2.8 and a viscosity | |
| | at 25 ° C. of 600 mPa · s | |

All the Inventive Examples and Comparative Examples were performed by a hand foaming technology comprising the steps of weighing the isocycnate-reactive component, siloxane (if any), surfactant, flame retardant, catalyst and water according to the formulations of Table 2 in a paper cup and mixing them with a high speed mixer (from Heidolph) at a rotation speed of 2000 r/m for 3 min to produce the “polyol package”; adding a targeted amount of blowing agent into the paper cup under thorough mixing, followed by a subsequent addition of the desired amount of a polyisocyanate component into the paper cup. All the substances in the paper cup were immediately mixed by a high speed mixer at a speed of 3000 r/m for 5 seconds and poured into a mold of the size 10 cm×20 cm×30 cm that had been preheated to 60° C. and placed vertically along the length direction for foaming. The foam was removed from the mold after about 30 min and placed in the lab bench overnight prior to physical properties testing.

The technologies for characterizing the thermal conductivity (K factor), density and compression strength of the resultant rigid PIR/PUR foams are described as follows.

Thermal Conductivity (K-Factor)

Foam specimens with a size of 20 cm×20 cm×2.5 cm were cut from the central position of the foams approximately 24 hours after the foams were produced and were subjected to characterization on a HC-074 heat flow meter instrument (EKO Instrument Trading Co., Ltd.) at 10° C. (with a lower plate temperature of 18° C. and a upper plate temperature of 2° C.) and 23° C. (with a lower plate temperature of 36° C. and a upper plate temperature of 10° C.) according to ASTM C518-04 in SDC. The measured value of the K-factor exhibits a variance of ±0.1 mW/mK.

Foam Density

The density of the rigid foams was measured according to ASTM 1622-03. In particular, foam specimens measuring 20 cm×20 cm×2.5 cm were cut from the central position of the foams approximately 24 hours after the foams were produced. The weight and exact dimension of the sample were measured, and the density was calculated accordingly. The measured value of the foam density exhibits a variance of around ±0.1 kg/m³.

Compression Strength

The compression strength was measured on a rigid foam with a size of 5 cm×5 cm×5 cm according to EN 826.

Comparative Examples 1 to 4 and Inventive Examples 1 to 3 were performed by using the formulations shown in Table 2. The formulations for all the Comparative Examples and Inventive Examples were particularly designed to achieve an identical NCO index of 4.27. The Inventive Examples were performed by using branched siloxanes b, c and d, while the Comparative Examples 1 to 4 did not comprise branched siloxanes. Particularly, Comparative Examples 3 and 4 comprised D10, which is a unbranched siloxane. The thermal conductivity (K factor), density and compression strength of the resultant rigid PIR/PUR foams were characterized and were also summarized in Table 2, wherein the unit for the amount of each ingredient was gram.

TABLE 2
The formulations and characterization results of the Inventive Examples (IE) 1
to 3 and Comparative Examples (CE) 1 to 4, wherein DC 5374 is short for VORASURF DC
5374, and B8421 is short for Tegostab B 8421.

| | | | CE3 | CE4 | IE1 | IE2 | IE3 |
|---|---|---|---|---|---|---|---|
| | CE1 | CE2 | DC5374 + | DC5374 + | DC5374 + | DC5374 + | DC5374 + |
| Formulations | B8421 | DC5374 | D10 | D10 | siloxane c | siloxane d | siloxane b |
| Polyester polyol F | 21.25 | 21.25 | 21.25 | 21.25 | 21.25 | 21.25 | 21.25 |
| Polyester polyol O | 63.75 | 63.75 | 63.75 | 63.75 | 63.75 | 63.75 | 63.75 |
| TEP | 15 | 15 | 15 | 15 | 15 | 15 | 15 |
| DC 5374 | | 3 | 3 | 3 | 3 | 3 | 3 |
| B8421 | 3 | | | | | | |
| D10 | | | 0.5 | 1 | | | |
| Siloxane c | | | | | 1 | | |
| Siloxane d | | | | | | 1 | |
| Siloxane b | | | | | | | 1 |
| Dabco K2097 | 1.9 | 1.9 | 1.9 | 1.9 | 1.9 | 1.9 | 1.9 |
| Polycat 5 (PC5) | 1 | 1 | 1 | 1 | 1 | 1 | 1 |
| Water | 0.8 | 0.8 | 0.8 | 0.8 | 0.8 | 0.8 | 0.8 |
| Cyclopentane | 21 | 21 | 21 | 21 | 21 | 21 | 21 |
| VORANATE M600 | 260 | 260 | 260 | 260 | 260 | 260 | 260 |
| Sum of polyol | 106.7 | 106.7 | 107.2 | 107.7 | 107.7 | 107.7 | 107.7 |
| Sum | 387.7 | 387.7 | 388.2. | 388.7 | 388.7 | 388.7 | 388.7 |
| Ohv eq | 0.44 | 0.44 | 0.44 | 0.44 | 0.44 | 0.44 | 0.44 |
| Iso Index | 4.27 | 4.27 | 4.27 | 4.27 | 4.27 | 4.27 | 4.27 |
| Core foam density | 40.4 | 41.8 | 40.3 | 38.6 | 40.4 | 41.0 | 40.0 |
| kg/m³ | | | | | | | |
| Average K factor | 19.1 | 19.1 | 19.2 | 19.2 | 18.6 | 18.8 | 18.7 |
| (10° C.) | | | | | | | |
| Compression | 130 | 129 | 125 | 100 | 122 | 120 | 124 |
| Strength in | | | | | | | |
| Thickness Direction | | | | | | | |
| kPa | | | | | | | |

It can be seen from the characterization results of Table 2 that CE3 and CE4, which comprised linear siloxane D10 fluid, did not show any improvement over CE1 and CE2, which did not comprise any siloxane component, in the K factor. On the other hand, IE1, IE2, and IE3, which comprised branched siloxanes b, c and d, did exhibit improved (i.e. lower) K factor over those of CE1 to CE4 while retaining comparable compression strength (Thickness Direction).

It is further noted that terms like “preferably,” “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present disclosure.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A composition for preparing polyisocyanurate and polyurethane foams, comprising:
A) an isocyanate-reactive component comprising one or more polyols;
B) a polyisocyanate component comprising one or more compounds having at least two isocyanate groups; and
C) a siloxane represented by Formula 1, 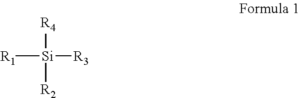
wherein each of R₁, R₂, R₃ and R₄ is independently selected from the group consisting of C₁-C₄ alkyl, trimethylsiloxy, tri(trimethylsiloxy)siloxy, di(trimethylsiloxy)methylsiloxy, (trimethylsiloxy)di(methyl)siloxy, a substituting group represented by Formula 2 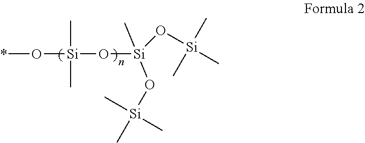
wherein n is an integer of 1, 2, 3, 4, 5, 6, 7, 8, 9 or 10, and * represents the point of attachment, and
a substituting group represented by Formula 3 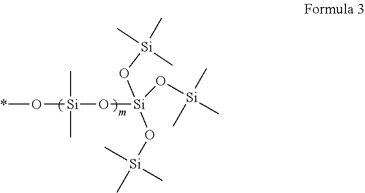
wherein m is an integer of 1, 2, 3, 4, 5, 6, 7, 8, 9 or 10, and * represents the point of attachment,
wherein one or more hydrogen atoms in the C₁-C₄ alkyl or methyl group of R₁, R₂, R₃ and R₄ are optionally substituted with a methyl or a trimethylsiloxy,
with the proviso that at most three of R₁, R₂, R₃ and R₄ are C₁-C₄ alkyl, and the siloxane comprises at least three trimethylsiloxy groups.

2. The composition according to claim 1, wherein the siloxane comprises from 3 to 50 trimethylsiloxy groups and 3 to 50 silicon atoms; at most two of R₁, R₂, R₃ and R₄ is C₁-C₄ alkyl, or at most one of R₁, R₂, R₃ and R₄ is C₁-C₄ alkyl, or none of R₁, R₂, R₃ and R₄ is C₁-C₄ alkyl; and the C₁-C₄ alkyl comprises methyl, ethyl, n-propyl, i-propyl, n-butyl, i-butyl, sec-butyl and t-butyl.

3. The composition according to claim 1, wherein the siloxane is represented by any one of the following formulae: 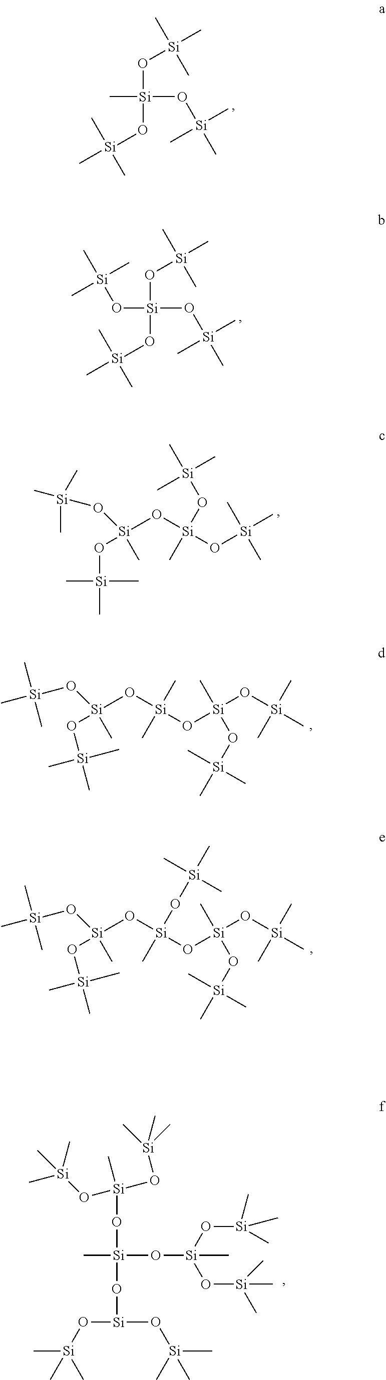 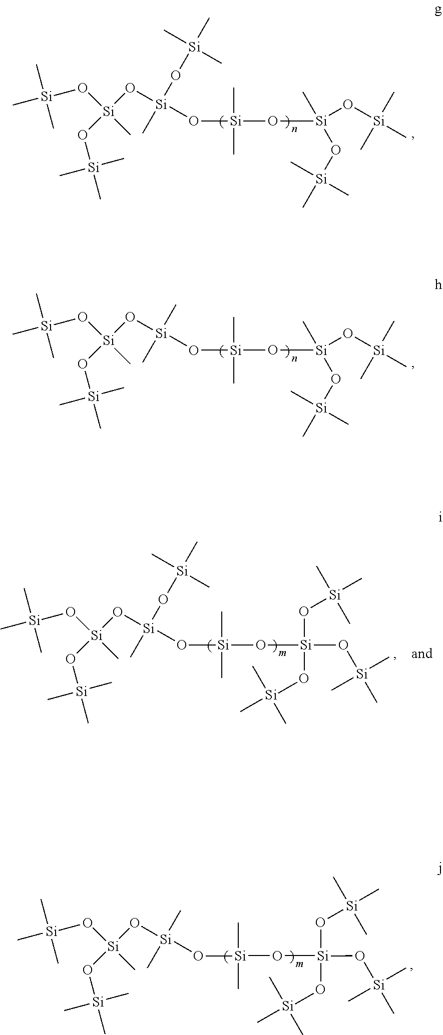
wherein each of n and m independently represents an integer of 1, 2, 3, 4, 5, 6, 7, 8, 9 or 10.

4. The composition according to claim 1, wherein the polyol is selected from the group consisting of C2-C16 aliphatic polyhydric alcohols comprising at least two hydroxy groups, C6-C15 cycloaliphatic or aromatic polyhydric alcohols comprising at least two hydroxy groups, C7-C15 araliphatic polyhydric alcohols comprising at least two hydroxy groups, polyester polyols having a molecular weight from 100 to 10,000, polyether polyols having a molecular weight from 100 to 4,000, and combinations thereof.

5. The composition according to claim 1, wherein the compounds comprising at least two isocyanate groups are selected from the group consisting of C₄-C₁₂ aliphatic polyisocyanates comprising at least two isocyanate groups, C₆-C₁₅ cycloaliphatic or aromatic polyisocyanates comprising at least two isocyanate groups, C₇-C₁₅ araliphatic polyisocyanates comprising at least two isocyanate groups, and isocyanate prepolymers obtained by reacting the C₄-C₁₂ aliphatic polyisocyanates comprising at least two isocyanate groups, C₆-C₁₅ cycloaliphatic or aromatic polyisocyanates comprising at least two isocyanate groups or C₇-C₁₅ araliphatic polyisocyanates comprising at least two isocyanate groups with one or more isocyanate-reactive compounds selected from the group consisting of ethylene glycol, 1,2-propanediol, 1,3-propanediol, 1,3-butanediol, 1,4-butenediol, 1,4-butynediol, 1,5-pentanediol, neopentylglycol, bis(hydroxy-methyl) cyclohexanes, 2-methylpropane-1,3-diol, methylpentanediols, diethylene glycol, triethylene glycol, tetraethylene glycol, polyethylene glycol, dipropylene glycol, polypropylene glycol, dibutylene glycol and polybutylene glycols.

6. The composition according to claim 1, wherein the composition comprises 20-70 wt %, or 30-60 wt %, or 30-50 wt % of the isocyanate-reactive component A) and 30-80 wt %, or 40-80 wt %, or 50-80 wt % of the polyisocyanate component B), based on the total amount of the composition; and
the composition comprises from 0.5 wt % to 8 wt %, or from 0.7 wt % to 5 wt %, or from 1 wt % to 3 wt % of the siloxane represented by Formula 1, based on the total weight of composition minus the weight of the polyisocyanate component B).

7. The composition according to claim 1, wherein the composition comprises a blowing agent D) selected from the group consisting of water, hydrocarbons and hydrofluorocarbons; and
the amount of the blowing agent D) is from 0.01 wt % to 40 wt %, or from 10 wt % to 25 wt %, based on the total weight of composition minus the weight of the polyisocyanate component B).

8. The composition according to claim 1, wherein the composition comprises a catalyst E) selected from the group consisting of tertiary amines; tertiary phosphines; metal chelates; ferric chloride, stannic chloride; organic acid salts of alkali metals, alkaline earth metals, Al, Sn, Pb, Mn, Co, Ni and Cu; metal complexes of tetravalent tin, trivalent and pentavalent As, Sb and Bi; and metal carbonyls of iron and cobalt; and
the amount of the catalyst E) is from 0.01 wt % to 10 wt %, or from 0.5 wt % to 5 wt %, based on the total weight of composition minus the weight of the polyisocyanate component B).

9. The composition according to claim 1, further comprising additives selected from the group consisting of co-catalyst, surfactant, toughening agent, flow modifier, adhesion promoter, diluent, stabilizer, plasticizer, catalyst de-activators, flame retardant and mixtures thereof;
wherein the total amount of the additives is from 0.01 wt % to 10 wt %, or from 0.5 wt % to 5 wt %, based on the total weight of composition minus the weight of the polyisocyanate component B).

10. A polyisocyanurate and polyurethane foam prepared with the composition according to claim 1, wherein the polyisocyanurate and polyurethane foam is formed by reacting the isocyanate-reactive component A) with the polyisocyanate component B) in the presence of the siloxane C).

11. A method for preparing a polyisocyanurate and polyurethane foam with the composition according to claim 1, comprising a step of reacting the isocyanate-reactive component A) with the polyisocyanate component B) in the presence of the siloxane C).
